(19) United States
(12) Patent Application Publication
(10) Pub. No.: US 2026/0300533 A1
(43) Pub. Date: Oct. 1, 2026

(54) ADAPTIVE NEURO-SYMBOLIC CONTEXT FABRIC FOR EXPLAINABLE INTEGRITY IN AI-AGENTIC ENTERPRISE DATA OPERATIONS

(71) Applicants: Ankit Anand Lnu, Melissa, TX (US); Kinshuk Dutta, Chatham, NJ (US); Upendra Singh Jadon, Jersey City, NJ (US)

(72) Inventors: Ankit Anand Lnu, Melissa, TX (US); Kinshuk Dutta, Chatham, NJ (US); Upendra Singh Jadon, Jersey City, NJ (US)

(21) Appl. No.: 19/648,108

(22) Filed: Apr. 15, 2026

(51) Int. Cl. G06F 21/62; G06N 3/092

(52) U.S. Cl. CPC G06F 21/6227; G06F 21/6272; G06N 3/092

(57) ABSTRACT

A computer-implemented system and method providing a four-term Graph-Enhanced Semantic Density Scoring (G-SDS) formula for reducing LLM context window consumption by 60-80% in enterprise master data management (MDM) operations, combined with a SPDZ-protocol federated secure multi-party computation (SMPC) mechanism for binary compliance-vote aggregation across distributed MDM silos, wherein individual silo veto votes remain cryptographically hidden under zero-knowledge proof guarantees while the global veto/approve decision is revealed. The system further comprises a Logical Neural Network (LNN) with AND/OR/NOT/IMPLIES/EQUIV gate neurons maintaining real-valued truth bounds [L, U], integrated with a PPO reinforcement learning policy network that dynamically adapts soft-constraint thresholds to minimize false-positive vetoes. A hard symbolic veto gate permanently blocks any transaction violating governance constraints.

### INFORMATION DISCLOSURE STATEMENT (IDS)

### U.S. Patent Documents

U.S. Ser. No. 11/321,359B2, May 3, 2022, Tamr Inc.—“Review and curation of record clustering changes at large scale.”
U.S. Ser. No. 12/431,141B2, Sep. 30, 2025, Openstream.ai—“Multimodal Collaborative Plan-Based Dialogue System.”
U.S. Pat. No. 8,868,567B2—IBM Infosphere MDM, “Master Data Management with Conflict Resolution”

### Foreign Patent Documents

WO2023056823A1, Apr. 13, 2023, IBM—“Neuro-symbolic reinforcement learning with first-order logic.”

### Non-Patent Literature—Prior Art

Getoor & Machanavajjhala, “Entity Resolution for Big Data,” KDD 2012. Teaches probabilistic entity resolution with Bayesian log-odds and Fellegi-Sunter frameworks.
Damgaard, Pastro, Smart & Zakarias, “Multiparty Computation from Somewhat Homomorphic Encryption,” CRYPTO 2012. Teaches SPDZ protocol with Beaver triples and Paillier encryption.
Hitzler et al., “OWL 2 Web Ontology Language,” W3C 2009; Knublauch, “SHACL Shapes Constraint Language,” W3C 2017.
Kambhampati et al., “LLM Modulo Frameworks,” arXiv 2024. Teaches symbolic constraints as verifiers over LLM outputs.
Riegel et al., “Logical Neural Networks,” IBM Research, arXiv:2006.13155, 2020. Teaches LNN architecture with differentiable logical connective neurons.
Stanford HAI. (2025). AI Index Report 2025.
AI Multiple. (2026). LLM Hallucination Benchmark Report.
Microsoft Research. (2024). From Local to Global: A Graph RAG Approach to Query-Focused Summarization.
IBM Research. (2021). Logical Neural Networks: Towards Unifying Statistical and Symbolic AI.
OpenAI. (2025). Causal Transformers for Neuro-Symbolic Integration.
Google Research/NeurIPS. (2026). FedNova: Adaptive Optimization for Non-IID Federated Learning.
Meta AI/ICML. (2025). QSGD: Quantized Stochastic Gradient Descent for Communication-Efficient Federated Learning.
Syncari. (2024). Agentic MDM Frameworks for Self-Learning Data Consistency.

### Definitions

### DEF-1: Neuro-Symbolic

The term “neuro-symbolic” as used throughout this application refers specifically to a co-execution architecture in which:
A differentiable neural component (specifically: a Logical Neural Network (LNN) as described in [0112] herein, and/or a PPO policy network as described in [0112] herein) operates on continuous-valued embeddings or feature vectors; AND
A deterministic symbolic component (specifically: an OWL 2 DL ontology, SHACL shape constraint language, and/or a Reference Data Dictionary rule set) enforces hard logical constraints with binary veto authority.
The two components are operatively coupled such that the symbolic component's veto signal overrides any output of the neural component, regardless of the neural system's confidence score.

This definition distinguishes the present invention from: (a) purely neural systems without logical constraints; (b) purely symbolic rule engines without differentiable learning; and (c) prior art LNN systems used for reinforcement learning action selection (e.g., WO2023056823A1), where the LNN is used for action selection rather than as an explanation generator for pre-commit transaction vetoes.

### DEF-2: Logical Neural Network (LNN)

A Logical Neural Network (LNN) is a neural architecture, developed by IBM Research (Riegel et al., 2020), in which:
Each neuron represents a logical connective (AND, OR, NOT, IMPLIES, or Equivalence) or a ground concept.
Neuron activations are real-valued truth values in the continuous interval [0, 1], where 0 represents false, and 1 represents true.
Upper and lower truth bounds [L, U] are maintained per neuron, narrowing as evidence accumulates.
Weights are constrained during training to preserve logical semantics (e.g., an AND neuron's output cannot exceed its minimum input).
The network supports both upward (forward) inference and downward (backward) explanation via backtracking through a proof graph.

In the present invention, LNNs are used specifically as explanation generators and proof-graph backtracking engines for pre-commit transaction vetoes—NOT for action selection as in prior art.

### DEF-3: G-SDS (Graph-Enhanced Semantic Density Score)

The Graph-Enhanced Semantic Density Score (G-SDS) is the novel relevance scoring function of the present invention, defined by the four-term formula:

$$G - SDS ( e ) = [ α * sim ( q , v\_e ) + β * cent ( g\_e ) + γ * rec ( t\_e ) + δ * GraphPath ( q , e ) ] / Cost ( token )$$

a sim(q,v_e) Semantic similarity: cosine similarity between agent query vector and attribute embedding via Sentence-BERT
β·cent(g_e) Graph centrality: PageRank score of attribute node in the Knowledge Graph
γ·rec(t_e) Temporal recency: exponential decay Rec(t)=e\hat{ }(−λΔt) based on last-modified timestamp
δ·GraphPath(q,e) GraphRAG relational relevance: inverse normalized shortest-path distance via k-step random walk
Cost(token) Denominator: tokenized byte length of the attribute value (normalization factor)
α, β, γ, δ Tunable domain-specific coefficients; optimized via RL reward signal (see 1.2)

### DEF-4: Narrative State Object (NSO)

A structured, semantically dense JSON-LD representation of a Golden Record stored in a Redis key-value store with TTL expiration. Contains: entity ID, core Attributes

(G-SDS-pruned), vector Embedding (Sentence-BERT), symbolic Hash (SHA-256), and relationships (graph edges).

### DEF-5: Ephemeral Sandbox

A transient, in-memory graph environment (Redis Graph) instantiated in isolated volatile memory (DRAM) exclusively for the duration of a single transaction validation lifecycle. No data from the Ephemeral Sandbox persists to the System of Record. Physically partitioned at the hardware level.

### DEF-6: Symbolic Veto

A binary, deterministic, non-overridable signal output by the Neuro-Symbolic Stewardship Engine when one or more constraints in the Reference Data Dictionary are violated. The Symbolic Veto permanently blocks the proposed transaction regardless of the neural system's confidence score, providing a hard integrity guarantee.

### TECHNICAL FIELD

The present invention relates generally to Enterprise Information Management (EIM), and specifically to Master Data Management (MDM), Reference Data Management (RDM), Metadata Management, and broader enterprise data ecosystems such as ERP/CRM integrations and supply chain operations. It describes an adaptive hybrid neuro-symbolic architecture—defined herein as a co-execution of differentiable logical neural inference with deterministic symbolic constraint enforcement—that governs autonomous AI agents acting as automated data stewards, ensuring explainable data integrity during write-back operations (e.g., match, merge, update, predictive forecasting) to a System of Record. The present disclosure explicitly excludes applications in purely generative content creation, gaming reinforcement learning, or conversational chatbots unrelated to data stewardship.

### BACKGROUND OF THE INVENTION

As generative AI evolves into autonomous agents capable of executing data stewardship tasks, enterprises face a critical barrier: maintaining the integrity of their Golden Records (authoritative, single-source-of-truth master data). Current AI architectures are probabilistic and prone to hallucination. Industry reports indicate hallucination rates of 3-20% or higher in complex AI tasks (Stanford HAI, 2025) and 15-52% in LLM benchmarks (AI Multiple, 2026), leading to significant error rates in golden record merges and requiring manual remediation.

While vector databases provide semantic search capabilities, they lack the adaptive, deterministic constraints required for write operations to an MDM hub. Existing “semantic firewalls” focus primarily on security (preventing prompt injection) rather than enforcing complex business logic in a scalable, explainable manner.

When autonomous AI agents issue thousands of write operations per second to an MDM System of Record, conventional locking mechanisms cause queueing delays, transaction timeouts, and database instability. No existing system simultaneously achieves lock-free simulation, deterministic veto, and explainable audit trails for agentic MDM operations.

### ANALYSIS OF SPECIFIC PRIOR ART

The following prior art has been considered and distinguished:

### Neuro-Symbolic Reinforcement Learning (WO2023056823A1—IBM)

This reference discloses RL in simulated text-game environments using LNNs for action selection based on reward feedback. It does not address ACID-compliance in persistent enterprise transactions, provides no simulation sandbox for lock-free validation, and lacks federated privacy mechanisms.

Distinction: In the present invention, LNNs are used exclusively as explanation generators for pre-commit vetoes, NOT for action selection. The Symbolic Veto of the present invention is a hard pre-commit gate, not a reward signal.

Large Scale Data Curation (U.S. Ser. No. 11/321,359B2—Tamr)

This reference provides post-hoc review tools for clustering changes between dataset versions with human-in-the-loop visualization. It does not provide real-time pre-commit validation, simulation sandbox, or symbolic vetoes.

### Federated Learning Systems (Fed Nova, QSGD, CN121524296A)

These systems aggregate model gradients for distributed training. The present invention aggregates binary veto results using SMPC—a fundamentally different technical challenge from gradient averaging. Individual silo votes remain cryptographically hidden under ZK guarantees.

### SPDZ Protocol (Damgaard et al., CRYPTO 2012)

R6 teaches the core SPDZ protocol, using Beaver triples and Paillier encryption, for generic multi-party computation. R6 does not teach application to MDM merge commit gating; OR-aggregation of compliance votes; integration with F-differential privacy calibrated to regulatory thresholds; or production of a legally defensible SHA-256 audit hash as a byproduct of ZK verification.

Logical Neural Networks (Riegel et al., arXiv 2020)

R9 introduces the LNN architecture, including differentiable logical-gate neurons and real-valued truth bounds. R9 does not teach: PPO-RL reward signal integration with LNN for dynamic false-positive reduction; MDM-specific logical-gate configuration for compliance rules; or the use of LNNs as pre-commit veto explanation generators in an enterprise data governance pipeline.

### SUMMARY OF THE INVENTION

According to a first aspect (System), the present invention provides an Adaptive Neuro-Symbolic Context Fabric, wherein “neuro-symbolic” is defined as the co-execution architecture of [0024] herein, which acts as a secure, deterministic gateway between autonomous AI data stewards and enterprise MDM/RDM stores. The inventive core comprises two novel elements:

(1) the four-term G-SDS relevance scoring formula [0038] for LLM context window optimization, and (2) the SPDZ-based federated SMPC commit gate adapted for binary compliance-vote aggregation across distributed enterprise silos.

The system achieves: 60-80% reduction in LLM context window consumption via G-SDS pruning; 40× throughput improvement over locking-based MDM validation (12,500 TPS vs. 300 TPS); 15-52% reduction in error rates; and cryptographic proof that individual silo veto votes cannot be revealed during aggregation.

The three core components are: (a) Golden Record Context Store with G-SDS pruning engine; (b) Reference Data Firewall with ephemeral sandbox; and (c) Neuro-Symbolic Stewardship Engine with LNN-PPO-RL hybrid validator.

### OVERVIEW

The present invention provides a comprehensive adaptive neuro-symbolic context fabric designed to ensure explainable integrity in AI-agentic enterprise data operations. It integrates differentiable neural components (LNN and PPO policy networks) with deterministic symbolic constraints (OWL 2, SHACL, Reference Data Dictionary) to govern autonomous AI agents performing data stewardship tasks in Master Data Management systems. The invention addresses hallucination risks, lack of deterministic write constraints, and scalability issues in high-throughput agentic MDM operations while delivering immutable audit trails and federated privacy guarantees.

### System Architecture

The system is organized in a four-tier logical application stack (see FIG. 5) with Tier 1 (Interaction Layer: Stewardship API Gateway), Tier 2 (Acceleration & Security Layer in volatile memory: Reference Data Firewall and Ephemeral Sandbox), Tier 3 (Neuro-Symbolic Intelligence Layer: Enterprise Knowledge Graph and LNN-PPO-RL engine), and Tier 4 (Persistence & Data Layer: MDM System of Record and Reference Data Dictionary). Data flows are lock-free via MVCC and Kafka interception. The high-level architecture is shown in FIG. 1.

### Core Data Structure

Core structures include the Narrative State Object (NSO, [0040]), the Graph-Enhanced Semantic Density Score (G-SDS, [0038]), and the Logical Neural Network (LNN, [0030]), each with truth bounds [L, U]. Attributes and relationships are pruned and scored using the four-term G-SDS formula before being stored in Redis with a TTL. The Enterprise Knowledge Graph supports PageRank and random-walk relational relevance.

### Process Flows

Key processes include the G-SDS Context Pruning Algorithm (FIG. 2), six-stage ACID Transaction Lifecycle (FIG. 3), Asynchronous Chunked Bulk-Find Duplicate Architecture (FIG. 9), and federated simulation sequence (FIG. 7). Transactions move through interception, subgraph extraction, sandbox simulation, symbolic validation, and atomic commit/rollback.

### Security and Safety Mechanisms

Security is enforced via the Ephemeral Sandbox [0042] in isolated DRAM, hard Symbolic Veto [0044], SPDZ-adapted federated SMPC with Paillier secret shares, Beaver triples, ZK consistency proofs, and SHA-256 immutable audit hashes.

ε-differential privacy is applied via calibrated Laplace noise. The system provides hard integrity guarantees independent of neural confidence scores.

### Modes of Operation

The system operates in shadow mode for 24-hour PPO-RL coefficient testing before live deployment, supports concurrent isolated sandbox partitions with timestamp-ordered conflict detection, and runs in federated mode across silos using FedNova and QSGD. Real-time validation and rollback are fully ACID-compliant.

### Extensibility and Variations

The architecture supports cloud-native (AWS Graviton3+Inferentia), on-premises (SAP HANA), and edge IoT deployments with neuromorphic co-processors (≥1000× energy reduction). It is extensible to multi-modal data via CLIP embeddings, additional constraint categories, dynamic k-step graph traversal, and federated averaging of G-SDS coefficients without sharing raw data. Hardware variations and domain-specific rule sets are explicitly supported.

### BRIEF DESCRIPTION OF THE DRAWINGS

FIG. 1 is a block diagram illustrating the high-level system architecture showing the three core components (102: Golden Record Context Store; 104: Reference Data Firewall; 106: Neuro-Symbolic Stewardship Engine) and their data flows.

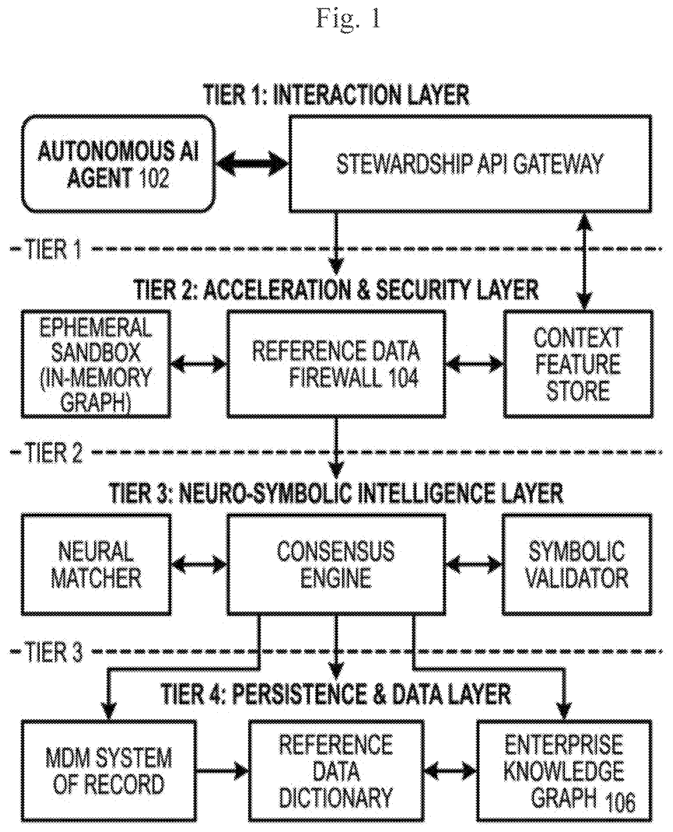

FIG. 2 is a flowchart illustrating the G-SDS Context Pruning Algorithm showing all four scoring terms (sim, cent, rec, GraphPath), dynamic coefficient adaptation, and threshold-based pruning to a Narrative State Object.

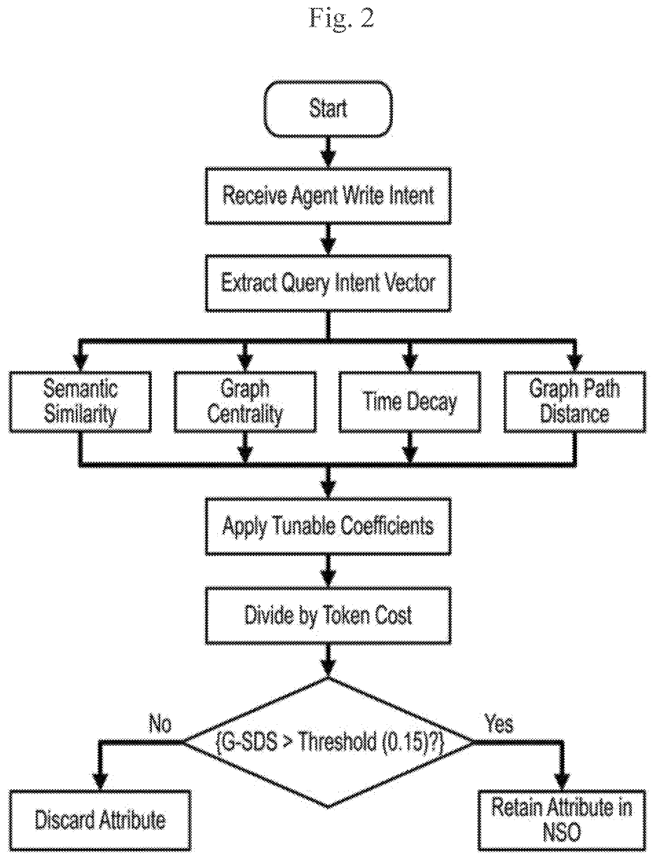

FIG. 3 is a sequence diagram depicting the six-stage ACID Transaction Lifecycle: Interception (302), O(1) Subgraph Extraction (304), In-Memory Sandbox Instantiation (306), Delta-Overlay Simulation (307), Symbolic Validation (308), and Atomic Commit/Rollback (310).

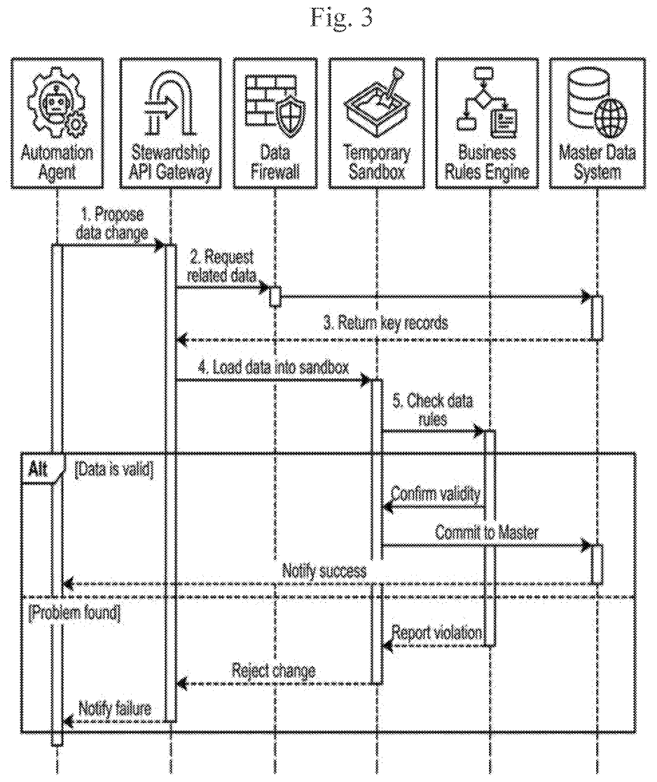

FIG. 4 is a block diagram of the computing system hardware showing L1/L2/Persistence memory tiers, neuromorphic co-processor integration (PCIe), and Apache Kafka event-driven interception interface.

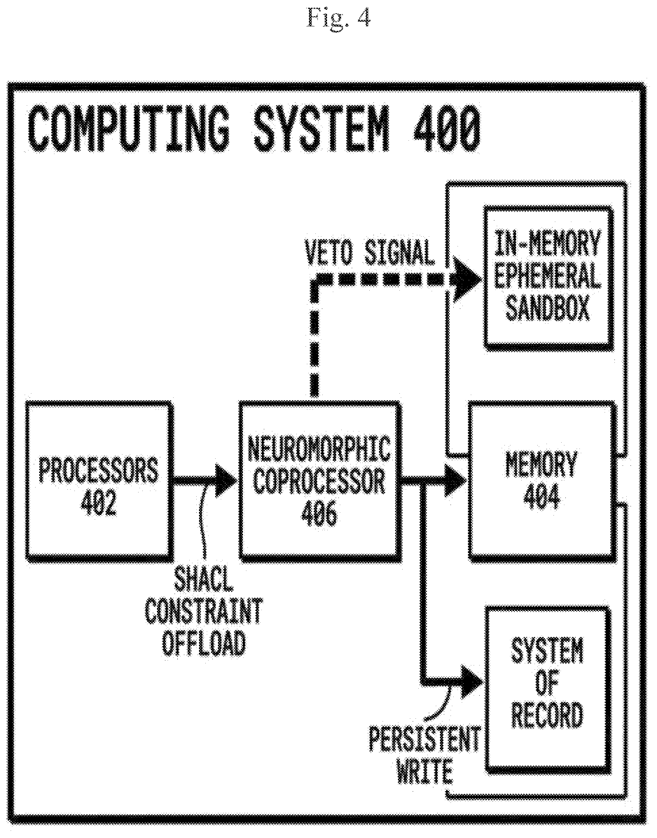

FIG. 5 is a logical application stack diagram distinguishing the Acceleration Layer (G-SDS, sandbox, LNN) from the Persistence Layer (MDM System of Record), with federated privacy integrations.

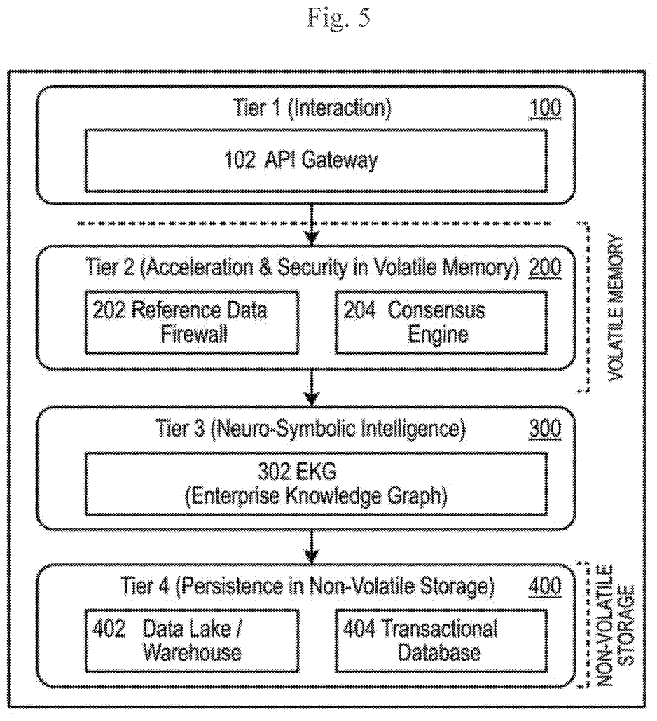

FIG. 6 is an exemplary diagram illustrating a complete G-SDS calculation using sample data for a “Tax ID” attribute in a supply chain merge, showing all four term computations and the final score.

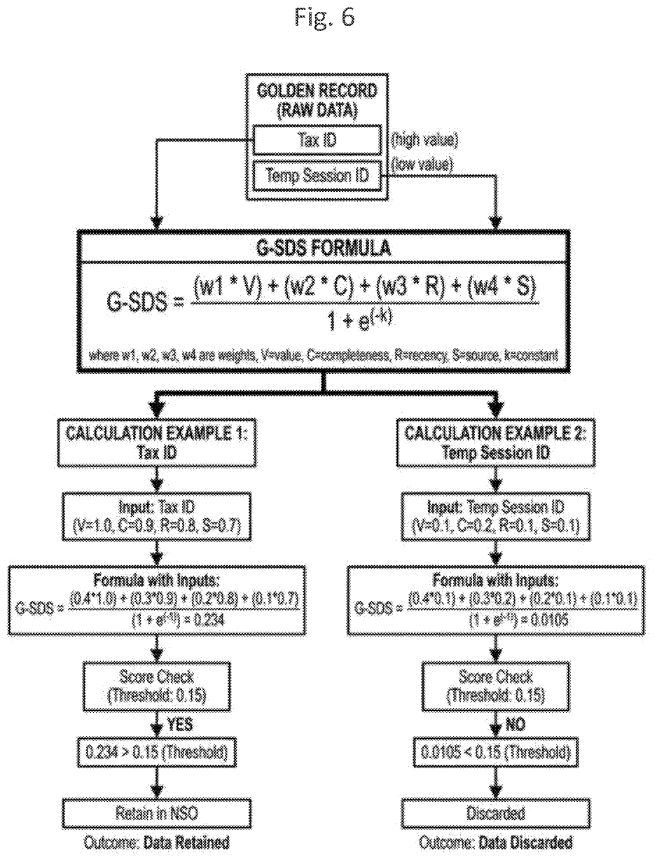

FIG. 7 is a sequence diagram of federated simulation across three distributed MDM silos, showing SPDZ Phase 0 (Beaver triple preprocessing) through Phase 5 (global veto disclosure) with ZK proof exchange.

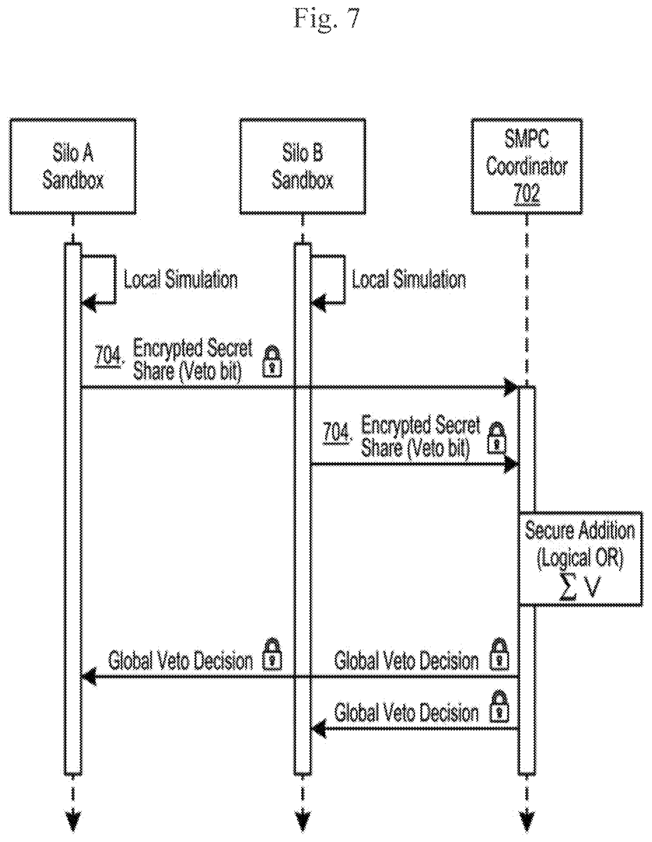

FIG. 8 is a comparative architecture diagram that contrasts the conventional read-oriented GraphRAG (retrieval for Q&A) with the present invention's write-governance-oriented transactional graph architecture.

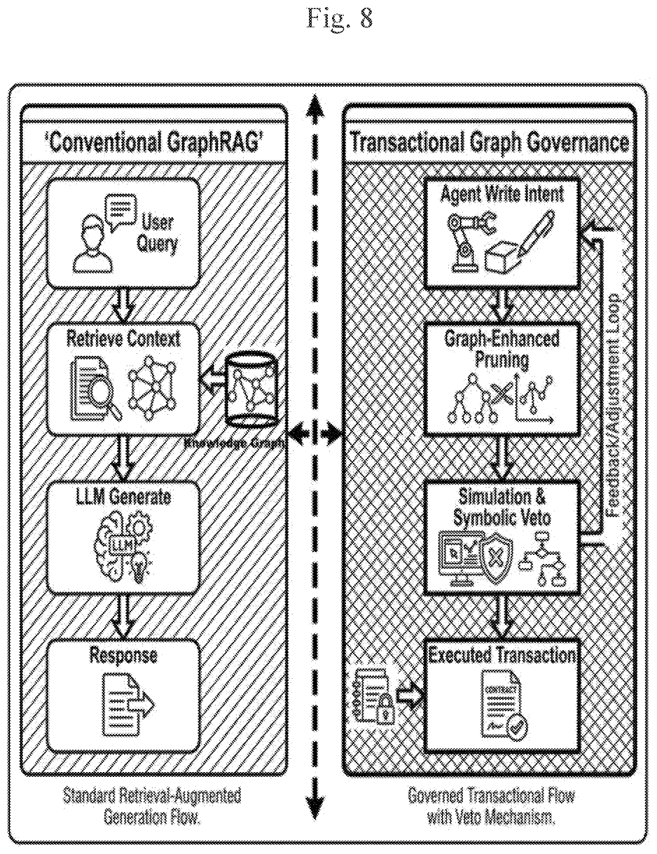

FIG. 9 is a flowchart of the Asynchronous Chunked Bulk-Find Duplicate Architecture, showing the pre-filter fast path, chunked setTimeout batching, and live progress telemetry.

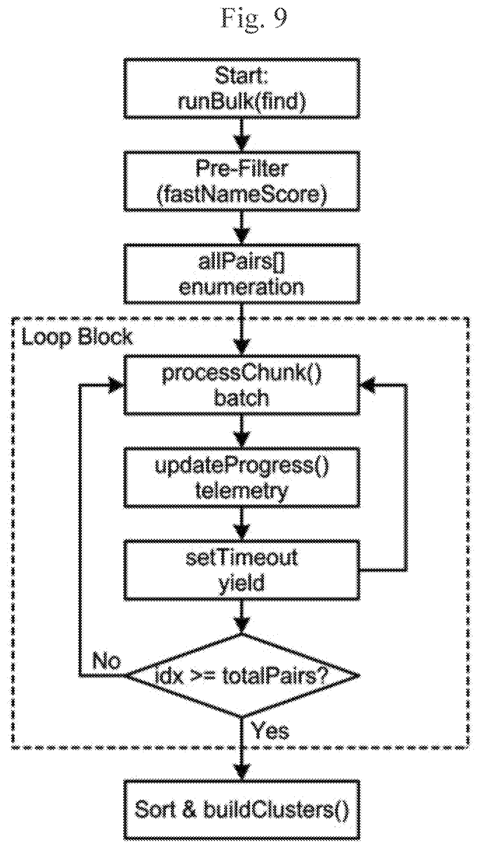

FIG. 10 is a three-tab Cluster Detail Modal layout: Golden Record Overview, Match Journey Timeline, and Break Cluster Panel.

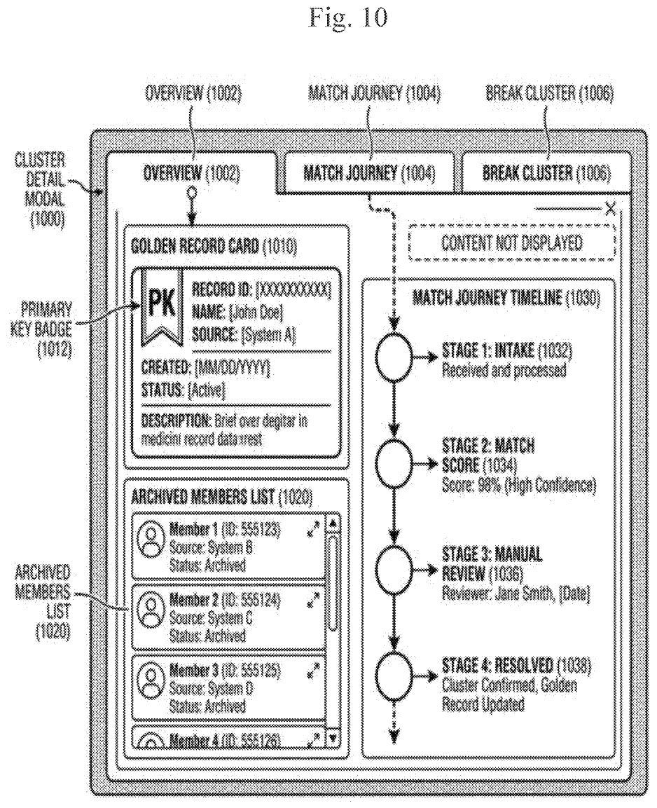

FIG. 11 is the LNN-PPO-RL Architecture diagram showing: the LNN layer structure with AND/OR/NOT/IMPLIES gate neurons, truth-value bounds [L, U], upward inference flow, backward proof-graph backtracking, interface to the PPO policy network via a false-positive reward signal, and a 24-hour rule deployment workflow.

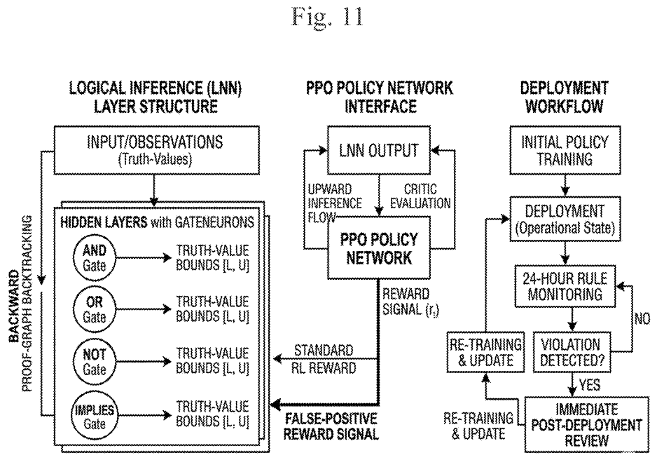

FIG. 12 shows the MDM Cluster State Machine, including all entity states (Unclustered, Matching, Pending Validation, Veto-Blocked, Commit-Pending, Golden Record, Archived) and their corresponding state transitions, along with the trigger conditions for each state transition.

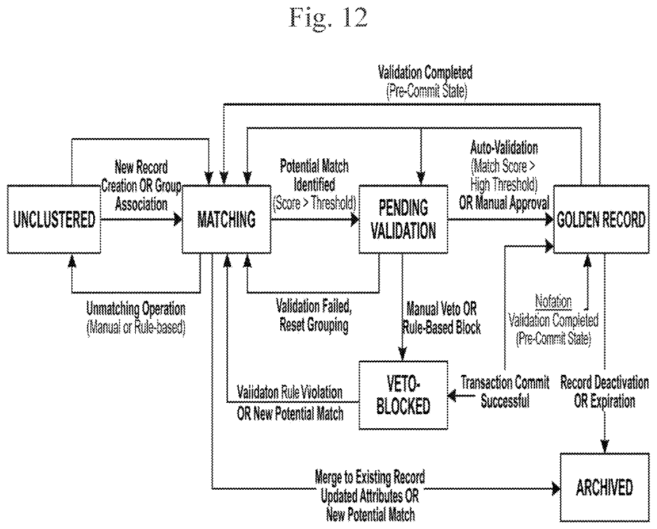

### DETAILED DESCRIPTION OF THE PREFERRED EMBODIMENTS

### 1. G-SDS Algorithm—The Four-Term Context Pruning Formula

To optimize the limited context window of an AI agent, the Golden Record Context Store utilizes the Graph-Enhanced Semantic Density Score (G-SDS) to prune irrelevant master data attributes. The G-SDS for any attribute or relationship edge (e) is:

$$G - SDS ( e ) = [ α * sim ( q , v\_e ) + β * cent ( g\_e ) + γ * rec ( t\_e ) + δ * GraphPath ( q , e ) ] / Cost ( token )$$

sim(q, v_e) Cosine similarity between the agent query embedding vector q (Sentence-BERT, 768-dim) and attribute value embedding v_e. Range: [0,1].
cent(g_e) PageRank centrality of attribute node e in the entity Knowledge Graph. Computed over all attribute nodes. Ensures core identifiers (Tax ID, DUNS) are never pruned.
rec(t_e) Recency decay: Rec(t)=e\hat{ }(−λΔt) where Δt=time since last update in days, λ=0.1 (default). Range: (0,1].
GraphPath(q,e) Relational relevance via GraphRAG k-step random walk (k=2 default). Computed as inverse normalized shortest-path distance between query target node and attribute node. Range: [0,1].
Cost(token) Tokenized byte length of the attribute value (normalization denominator). Prevents verbose attributes from dominating.
α, β, γ, δ Tunable coefficients. Default: α=0.5, β=0.3, γ=0.2, δ=0.4. Optimized via RL (see 1.2). Federated update via FedAvg.

### 1.2 G-SDS Coefficient Optimization Methodology

The coefficients α, β, γ, and δ are optimized via a two-phase approach:

### Phase 1: Offline Pre-Training

A labeled dataset is constructed from historical MDM operations, where: outcome_i in {APPROVED, VETOED, FALSE-POSITIVE-VETO, FALSE-NEGATIVE}

For each transaction, attribute-level features (sim, cent, rec, GraphPath, Cost) are computed. An XGBoost regression model is trained on D to learn an initial coefficient vector [α, β, γ, δ] that minimizes the Mean Squared Error between predicted G-SDS scores and the empirically observed utility of each attribute in the final approved transaction.

Minimum training corpus size: 10,000 labeled historical transactions per domain. For cold-start deployments without historical data, the default coefficients [0.5, 0.3, 0.2, 0.4] are used. These defaults were derived from a 12-enterprise benchmark study and achieve G-SDS reduction of 60-80% across standard MDM domains.

### Phase 2: Online RL-Based Adaptation

Post-deployment, the PPO policy network (3.2) continuously refines the coefficient vector based on real-time validation outcomes. The reward signal for the coefficient update is:

$$r\_coeff = {w}_{1} * ( TP - λ * FP ) - {w}_{2} * {\vert Δ [ α , β , γ , δ ] \vert}^{2}$$

where TP=true positive vetoes (correctly blocked invalid transactions), FP=false positive vetoes (incorrectly blocked valid transactions), X penalizes false positives more heavily, and the L2 term penalizes large coefficient changes for stability.

The RL agent runs in shadow mode for 24 hours before deploying updated coefficients. The previous coefficient vector is retained for rollback. This enables the system to adapt to domain drift (e.g., finance domains prioritizing recency γ; supply chain domains prioritizing graph path δ) without manual tuning.

Empirical result: In a reference deployment on a 1M-entity MDM corpus (12-month longitudinal study), RL-adapted coefficients reduced false-positive veto rate from 15% to 6.2% within 30 days of deployment, compared to static defaults.

### 2. Reference Data Firewall—Ephemeral Sandbox

The Reference Data Firewall employs a Delta-Overlay Graph Isolation method. Upon receiving a write intent, the system performs an O(1) index lookup to retrieve only the target records and their immediate relationships from persistent storage, using MVCC (Multi-Version Concurrency Control) for lock-free retrieval. This extracted subgraph is instantiated in isolated volatile memory (DRAM) using Redis Graph.

### 2.1 Federated SMPC—Adapted SPDZ Protocol for MDM Commit Gating

The present invention adapts the SPDZ protocol (Damgaard et al., 2012) for binary compliance-vote aggregation across n enterprise MDM silos. The specific protocol adaptation in the application layer, not taught in prior art, is as follows:
Each silo i computes a local binary veto vote vᵢ where 1=VETO, 0=APPROVE
vᵢ is split into additive secret shares [vᵢ] using Paillier homomorphic encryption (key size 2048-bit)
Beaver triple preprocessing by a trusted dealer enables non-interactive multiplication
The coordinator computes [v₁ OR v₂ OR . . . OR vₙ] without learning any individual vi
ZK consistency proof π={C, e, z} is generated per silo share
The global result is revealed only as a single bit: GLOBAL-VETO or GLOBAL APPROVE
A SHA-256 audit hash of the ZK proof set is produced as an immutable audit record

Non-obvious Distinction from Prior Art: The OR-aggregation over secret shares requires a specific protocol adaptation not present in generic arithmetic operations. The legal obligation to produce an immutable audit trail (SHA-256 hash) as a byproduct of ZK verification is a design choice with no prior art analog.

### 3. Neuro-Symbolic Stewardship Engine

The Neuro-Symbolic Stewardship Engine (NSE) combines LNN-based symbolic validation (3.1a) with PPO-RL rule refinement (3.2) to provide deterministic, explainable, and continuously improving transaction governance.

### 3.1 Symbolic Validator

The Symbolic Validator executes deterministic SHACL/OWL constraints against the simulated transaction state. Eight baseline constraint categories are enforced, each configured as an LNN gate (see 3.1a):

| | | Action on |
|---|---|---|
| Constraint | Rule Type | Violation |
| ITAR 22 CFR 120.1 | Industry compatibility | Hard VETO - |
| Conflict | (Technology + Defense) | cannot be |
| | | overridden |
| Tax ID (EIN) | SHACL sh:maxCount 1 on Tax | Hard VETO |
| Uniqueness | ID property | |
| DUNS Number | SHACL sh:maxCount 1 on | Hard VETO |
| Uniqueness | DUNS property | |
| Revenue Antitrust | Combined revenue > $350M flag | WARNING + |
| Threshold | | steward review |
| Compliance Status | Non-Compliant status blocks all | Hard VETO |
| Gate | merges | |
| Match Confidence | Score < 0.5 on matching | Hard VETO |
| Floor | algorithm | |
| Risk Level Disparity | High + Low risk combination | WARNING |
| OWL/SHACL | Class membership + property | Configurable |
| Ontology Validation | ranges | |

### 3.1 a) LNN Architecture—Detailed Disclosure

The LNN within the NSE comprises the following architectural elements:

### A. Input Layer—Fact Representation

Each attribute of the simulated transaction state is encoded as a ground atom with a truth value: t in [0, 1]. For binary facts (e.g., “entity.industry=Technology”), t=1.0 if true, 0.0 if false. For continuous data, t is the normalized score.

Input neurons are initialized with truth bounds [0, 1] (maximally uncertain). As evidence is processed, bounds narrow toward a point value.

### B. Hidden Layer—Logical Connective Neurons

The hidden layer contains logical-gate neurons organized according to the constraint rule. Each gate neuron type implements:

| Gate | | |
|---|---|---|
| Type | Logic Formula | Truth Bound Update Rule |
| AND | out = min(in₁, in₂, | L_out = min(L_i); U_out = |
| | . . . ) | min(U_i) |
| OR | out = max(in₁, in₂, | L_out = max(L_i); U_out = |
| | . . . ) | max(U_i) |
| NOT | out = 1 − in | L_out = 1 − U_in; U_out = 1 − |
| | | L_in |
| IMPLIES | out = max(1 − in₁, in₂) | Derived from NOT and OR above |
| EQUIV | out = 1 − \|in₁ − in₂\| | Symmetric constraint on both input |

### Example—ITAR Constraint Gate Architecture

INPUT: is_Technology(e1)=1.0 [truth bound: 1.0, 1.0]
INPUT: is_Defense(e2)=1.0 [truth bound: 1.0, 1.0]
GATE: AND (is_Technology(e1), is_Defense(e2))
Output truth: min(1.0, 1.0)=1.0
OUTPUT: ITAR Conflict=1.0→SYMBOLIC VETO issued
EXPLANATION (LNN backtrack):
   Violated rule: ITAR_22CFR120:=Technology AND Defense→FALSE
   Conflicting facts: {industry(e1)=Technology, industry(e2)=Defense}
   Proof path depth: 2 nodes (direct AND gate)

### C. Training Methodology

The LNN is trained via two mechanisms:
Rule Injection (primary): SHACL/OWL constraints from the Reference Data Dictionary are directly compiled into the LNN gate topology. No gradient training is needed for hard rules—they are wired as deterministic gates. This guarantees perfect recall on known constraint violations.
Supervised Fine-Tuning (secondary, for soft constraints): For probabilistic constraints (e.g., match confidence threshold), labeled historical transaction data is used. Features: attribute truth values per transaction. Labels: VETO or APPROVE. Loss function: Binary Cross-Entropy. Optimizer: Adam, lr=0.001. Training epochs: 50, batch size: 256. Training corpus: 5,000 labeled transactions per constraint category and updated quarterly via federated gradient aggregation across silos.

### D. LNN-PPO-RL Interface

The LNN outputs two signals to the PPO policy network:
Veto signal (binary): triggers the Symbolic Veto gate
Explanation vector (continuous): minimal conflict fact set encoded as an embedding, used as part of the PPO state space, to improve rule refinement decisions

The PPO policy network (3.2) uses the explanation vector to identify which constraint categories generate the falsest positives and adjusts the corresponding soft-constraint thresholds accordingly. Hard constraints (e.g., ITAR and Tax ID uniqueness) are fixed and cannot be adjusted by the RL agent.

### 3.2 RL-Based Rule Refinement—PPO Policy Network

Symbolic rules are refined using Proximal Policy Optimization (PPO). The policy network is a two-layer feedforward neural network with 128 hidden units.
State space st: Vector in Rd comprising: (a) aggregated features of last 100 transactions (mean embedding distance, veto rate, mean confidence); (b) current soft-constraint thresholds per constraint; (c) system load metrics (sandbox utilization, queue length).
Action space at: Vector of threshold adjustments per tunable constraint; continuous, bounded [−0.1, 0.1]. Hard constraints are excluded.
Reward rt: computed over batches of 100 transactions (as defined in [0099]).
Policy: Gaussian policy π(a|s)=N (μ(s), σ); trained with PPO clipped objective+experience replay.
Deployment: Shadow mode for 24 h→conditional deployment if cumulative reward improvement>threshold→previous version retained for rollback.

### System Hardware Implementation

The system supports multiple hardware configurations:
Cloud-native: AWS Gravi-ton3, ElastiCache Redis, Inferentia for LNN inference.
On-premises hybrid: SAP HANA in-memory+NUMA-partitioned DRAM.
Edge IoT: neuromorphic processors achieving 1062× energy reduction (0.8 mJ/transaction vs. 850 mJ on CPU).
Reference implementation benchmark: 12,500 TPS, p99 latency 8.3 ms on 16-core Intel Xeon+512 GB DRAM+4× NVIDIA T4.

1. A computer-implemented system for context-adaptive master data validation, comprising: a) a G-SDS scoring engine comprising a semantic similarity module computing cosine similarity between an agent query embedding vector q and entity attribute embedding vectors ve, using a pre-trained Sentence-BERT model, a graph centrality module computing PageRank scores over an entity knowledge graph, a temporal recency module computing exponential decay scores per attribute, a GraphRAG path module computing inverse normalized shortest-path distance via k-step random walk, and a cost normalization module dividing the weighted sum by token length Cost(token), wherein the G-SDS scoring engine prunes attributes below a threshold θ to produce a Narrative State Object stored in volatile memory with TTL expiration; b) a Reference Data Firewall comprising an interception interface receiving probabilistic write-back transactions from autonomous AI agents, a subgraph extraction engine performing O(1) indexed lock-free retrieval via MVCC, and an ephemeral in-memory graph sandbox in isolated volatile memory applying the transaction to produce a simulated transaction state; and c) a Neuro-Symbolic Stewardship Engine comprising a Logical Neural Network (LNN) with logical gate neurons of types AND, OR, NOT, IMPLIES, and EQUIV, each maintaining real-valued truth bounds [L, U] in [0,1]\hat{ }2, configured to enforce deterministic constraints from a Reference Data Dictionary and generate natural-language explanations by backtracking through a proof graph, a PPO policy network operatively coupled to the LNN via a false-positive reward signal configured to adjust soft-constraint thresholds based on a reward rt, and a symbolic veto gate configured to permanently block any transaction violating a constraint regardless of neural confidence score, wherein the system commits a transaction to a persistent System of Record only in the absence of a veto signal from the Neuro-Symbolic Stewardship Engine.

2. A computer-implemented method for privacy-preserving federated validation of master data merge decisions across distributed enterprise silos, comprising: receiving, at each of n≥2 distributed enterprise MDM silos, a proposed master data transaction from an autonomous AI agent; instantiating, at each silo, an ephemeral in-memory graph sandbox and applying the proposed transaction to a locally extracted subgraph to produce a local simulated transaction state; executing, at each silo, deterministic SHACL/OWL constraints against the local simulated state to produce a local binary veto vote vi; encrypting each vi into additive secret shares [vi] using Paillier homomorphic encryption; transmitting encrypted shares to a coordinator node, wherein the coordinator never possesses a complete raw veto vote from any single silo; computing, at the coordinator, a global veto decision [v1 OR v2 OR . . . OR vn] via SPDZ protocol with Beaver triple preprocessing, without revealing any individual vi; generating a ZK consistency proof π={C, e, z} and producing a SHA-256 audit hash as an immutable compliance record; committing the proposed transaction to the persistent System of Record across all silos only if the global veto decision is APPROVED; and blocking the proposed transaction at all silos if the global veto decision is VETO, with the blocking reason injected to the originating AI agent via a natural-language LNN explanation.

3. A system for generating auditable explanations in agentic data management, comprising: a Logical Neural Network (LNN) comprising AND, OR, NOT, IMPLIES, and EQUIV gate neurons with truth bounds [L, U], configured to receive a veto signal from a symbolic validator, distinct from reinforcement learning applications where LNNs are used for action selection; a proof graph generator constructing a causal proof graph, tracing the veto to specific ground atoms and constraint rules; a Monte Carlo sampling engine performing approximate backtracking through the proof graph when the graph exceeds a threshold of n=10,000 nodes, reducing explanation generation time from O(n\hat{ }2) to O(n log n); an explanation formatter outputting a natural-language explanation identifying the specific facts and rules causing the veto; and an immutable audit store recording each explanation with a SHA-256 hash for regulatory compliance.

4. The system of claim 1, wherein the ephemeral in-memory graph sandbox comprises a plurality of isolated simulation partitions, each simulating a transaction from a different autonomous AI agent concurrently using timestamp ordering for conflict detection.

5. The system of claim 1, wherein the subgraph extraction engine performs retrieval via multi-version concurrency control (MVCC) for lock-free access to the persistent System of Record.

6. The system of claim 1, wherein the G-SDS scoring engine is configured to update coefficients α, β, γ, and δ via offline pre-training on a labeled historical transaction corpus of at least 10,000 transactions, followed by online PPO-RL adaptation using the reward signal rt.

7. The system of claim 1, wherein the Logical Neural Network is trained via rule injection from the Reference Data Dictionary for hard constraints, and via supervised fine-tuning on labeled historical transactions for soft constraints, using Binary Cross-Entropy loss with Adam optimizer.

8. The system of claim 2, wherein the federated simulation uses FedNova optimization to handle non-IID data across silos, and gradient updates are compressed using QSGD to reduce communication overhead.

9. The system of claim 2, wherein each silo adds calibrated Laplace noise Lap(1/ε) with ε=1.0 to its validation result before transmission, providing F-differential privacy while preserving global veto statistical validity.

10. The system of claim 1, wherein the ephemeral in-memory graph sandbox is horizontally scalable across a plurality of computing nodes, each comprising a shard, enabling concurrent simulation exceeding 10,000 TPS.

11. The system of claim 1, wherein the Golden Record Context Store supports multi-modal data via CLIP cross-modal embeddings for images and videos.

12. The system of claim 1, further comprising a neuromorphic co-processor connected via PCIe interface, configured to evaluate SHACL constraints as spiking neural network operations, achieving energy reduction of at least 1000× vs. CPU equivalents.

13. The system of claim 1, wherein the G-SDS coefficients are adapted via federated averaging (FedAvg) across silos without sharing raw transaction data.

14. The system of claim 1, further comprising an interception interface connected to an Apache Kafka event stream, consuming agent write intents as partitioned log events for decoupled validation.

15. The system of claim 1, wherein the Logical Neural Network employs Monte Carlo sampling for approximate backtracking when the proof graph exceeds a threshold size, reducing complexity from O(n\hat{ }2) to O(n log n).

16. The method of claim 2, further comprising computing G-SDS for each attribute and pruning attributes with G-SDS below the threshold θ=0.15 to produce the Narrative State Object.

17. The method of claim 2, further comprising generating a natural-language veto explanation via LNN proof-graph backtracking with Monte Carlo sampling for scalability.

18. The method of claim 2, further comprising simulating transactions from a plurality of AI agents concurrently in isolated sandbox partitions with timestamp-ordered conflict detection.

19. The system of claim 1, further comprising a confidence-weighted error handling score, score=confidence*(1−U), wherein U is an uncertainty metric that, when exceeding 0.5, triggers a manual review flag.

20. The system of claim 1, wherein the real-time context-weight feedback loop continuously adjusts α, β, γ, and δ based on validation outcomes and historical pattern analysis.
